(19) United States
(12) Patent Application Publication
(10) Pub. No.: US 2025/0266436 A1
(43) Pub. Date: Aug. 21, 2025

(54) NEGATIVE ELECTRODE MATERIAL FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: TDK Corporation, Tokyo (JP)

(72) Inventors: Shin FUJITA, Tokyo (JP); Takashi MORI, Tokyo (JP)

(73) Assignee: TDK Corporation, Tokyo (JP)

(21) Appl. No.: 19/019,570

(22) Filed: Jan. 14, 2025

Related U.S. Application Data
(63) Continuation of application No. PCT/JP2024/005956, filed on Feb. 20, 2024.

(51) Int. Cl. H01M 4/38; H01M 4/36; H01M 4/62; H01M 10/0525; H01M 10/42

(52) U.S. Cl. CPC H01M 4/386; H01M 4/366; H01M 4/62; H01M 10/0525; H01M 10/4235

(57) ABSTRACT

This negative electrode material for a lithium ion secondary battery may include silicon particles. The silicon particles may have an average particle size of 1 μm or more and 10 μm or less. Each of the silicon particles may have an internal region and a surface region. The surface region may include amorphous silicon or silicon having a crystallite size of 200 nm or less. The internal region may include silicon having a crystallite size of more than 200 nm.

### CROSS-REFERENCE TO RELATED APPLICATION

The present application is a bypass continuation of International Patent Application No. PCT/JP2024/005956, filed on Feb. 20, 2024, which is hereby incorporated by reference in its entirety.

### TECHNICAL FIELD

The present disclosure relates to a negative electrode material for a lithium ion secondary battery, a negative electrode for a lithium ion secondary battery, and a lithium ion secondary battery.

### BACKGROUND ART

Lithium ion secondary batteries are widely used as power sources for mobile devices such as mobile phones and notebook computers and for hybrid cars.

The capacity of a lithium ion secondary battery depends mainly on an active material of an electrode. Graphite is generally used as a negative electrode active material, but there is a demand for a negative electrode active material with a higher capacity. For this reason, silicon (Si), which has a theoretical capacity far higher than that of graphite (372 mAh/g), has attracted attention.

A negative electrode active material including silicon undergoes significant volume expansion during charging. The volume expansion of the negative electrode active material causes a decrease in the cycle characteristics of the battery. When the negative electrode active material expands in volume, for example, the negative electrode active material is damaged, a conductive path between the negative electrode active materials is cut, peeling occurs at an interface between a negative electrode active material layer and a current collector, or cracks occur in a solid electrolyte interphase (SEI) coating film; and thereby, decomposition of an electrolytic solution is caused. This decreases the cycle characteristics of the battery.

For example, Patent Document 1 describes that the cycle characteristics are improved by defining the aspect ratio of a silicon particle and the inclination angle of the silicon particle with respect to the current collector.

### CITATION LIST

### Patent Document

Patent Document 1: Japanese Unexamined Patent Application, First Publication No. 2019-149333

### SUMMARY OF DISCLOSURE

### Technical Problems

The cycle characteristics are an important parameter, and it is desirable to be able to improve the cycle characteristics by a method other than the method described in Patent Document 1.

The present disclosure has been made in view of the above and other problems, and an object of the present disclosure is to provide a lithium ion secondary battery having excellent cycle characteristics.

### Solution to Problems

The following solutions according to some embodiments of the present disclosure are provided to solve the above and other problems.

A negative electrode material for a lithium ion secondary battery according to a first aspect includes silicon particles. The silicon particles have an average particle size of 1 μm or more and 10 μm or less. Each of the silicon particles has an internal region and a surface region. The surface region includes amorphous silicon or silicon having a crystallite size of 200 nm or less. The internal region includes silicon having a crystallite size of more than 200 nm.

### Advantageous Effects of Disclosure

A lithium ion secondary battery using the negative electrode material for a lithium ion secondary battery according to some embodiments of the present disclosure has excellent cycle characteristics.

### BRIEF DESCRIPTION OF DRAWINGS

FIG. 1 a TEM image of a cross-section of a negative electrode material for a lithium ion secondary battery according to a first embodiment.

FIG. 2 a schematic diagram of a lithium ion secondary battery according to the first embodiment.

### DESCRIPTION OF EMBODIMENTS

Hereinafter, embodiments will be described in detail with reference to the drawings as appropriate. In the drawings which will be used in the following description, featured portions may be enlarged for convenience in order to make the features easy to understand, and the dimensional ratios of constituent elements may be different from the actual ones. The materials, dimensions, and the like which will be exemplified in the following description are examples, and the present disclosure is not limited thereto and can be appropriately modified and carried out without changing the features of the present disclosure.

### “Negative Electrode Material”

A negative electrode material according to a first embodiment is used in a lithium ion secondary battery and includes silicon particles. The negative electrode material according to the first embodiment functions as, for example, a negative electrode active material.

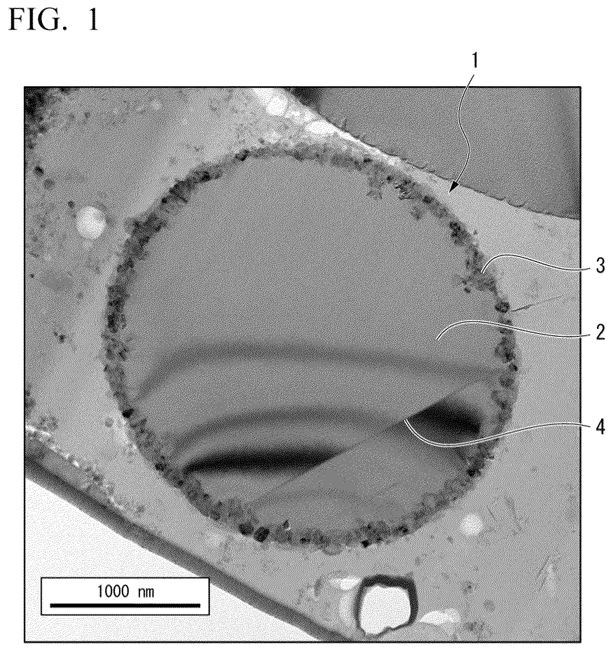

FIG. 1 is a transmission electron microscope (TEM) image of a cross section of the negative electrode material according to the first embodiment, which is measured using a TEM. A silicon particle 1 has an internal region 2 and a surface region 3.

The internal region 2 is a region located inside the surface region 3. The internal region 2 includes a single crystal of silicon. The internal region 2 may be a polycrystalline body formed by aggregation of single crystals.

In a case in which the internal region 2 is a polycrystalline body, a grain boundary 4 is observed within the internal region 2. When the grain boundary 4 is present within the internal region 2, lithium ions are diffused along the grain boundary, and thus the lithium ions easily reach the inside of the silicon particle 1. When the lithium ions reach the inside of the silicon particle 1 uniformly, it is possible to prevent the stress caused by the expansion and contraction of the silicon particle 1 from concentrating locally, and thus it is possible to prevent the silicon particle 1 from being damaged during charging and discharging of the lithium ion secondary battery.

The internal region 2 includes silicon having a crystallite size of 200 nm or more. The crystallite size of the crystal of the internal region 2 is, for example, 200 nm or more and 2000 nm or less, preferably more than 200 nm and 1500 nm or less, and preferably 300 nm or more and 1000 nm or less. In the silicon particle 1, the internal region 2 is mainly responsible for the absorption and release of the lithium ions. The larger the crystallite size of the crystal of the internal region 2, the smoother the charging and discharging of the lithium ions. The crystallite size can be observed from a TEM image.

The internal region 2 mainly includes silicon. The internal region 2 may include silicon oxide, denoted as SiOₓ. For example, x satisfies 0.8≤x≤2. For example, the internal region 2 may include a silicon carbon composite material (Si—C).

The surface region 3 is formed in the surface of the silicon particle 1. The surface region 3 is a region of the silicon particle 1 outside a closed space drawn by connecting positions that are 75% of a length from the geometric center of a line segment that connects the geometric center of the silicon particle 1 to the outer surface of the silicon particle 1. The geometric center is a point at which a long axis and a short axis intersect with each other in a TEM cross section of the silicon particle 1.

The surface region 3 includes amorphous silicon or silicon having a crystallite size of 200 nm or less. The surface region 3 includes silicon having a crystallite size of, for example, 5 nm or more and 200 nm or less.

The crystal of the internal region 2 has a large crystallite size, and a path through which the lithium ions can enter is limited. In contrast, when the surface region 3 is amorphous or has the crystal having a small crystallite size, the lithium ions can enter the inside of the silicon particle 1 in various directions. This is because the amorphous silicon does not have a crystal orientation, and the silicon having a small crystallite size has crystal orientations in different directions. By covering the surface of the internal region 2 with the surface region 3, the diffusion of the lithium ions within the silicon particle 1 becomes uniform, and a local volume change in the silicon particle 1 can be suppressed.

The surface region 3 may include at least one metal element selected from the group consisting of Mg, Al, Ca, Ti, V, Cr, Mo, Mn, Fe, Co, Ni, Cu, and Zn. The metal element may be present as a simple substance or in the form of a compound with other elements. For example, the metal element may be present as a silicide. For example, FeSi₂, FeSi, Fe₃Si, CrSi₂, NiSi₂, MoSi₂, VS₂, Mg₂Si, and TiSi₂ are examples of the silicide.

The metal element distorts the crystal structure of the silicon. When the crystal structure of the silicon is distorted, the entering path of the lithium ions is not fixed in a predetermined direction, the diffusion of the lithium ions within the silicon particle 1 becomes uniform, and a local volume change in the silicon particle 1 can be suppressed. The metal element is preferably present at a position in contact with the silicon.

The molar ratio of the metal element in the surface region 3 is, for example, 1 mol % or more and 40 mol % or less, and preferably 3 mol % or more and 30 mol % or less. In the molar ratio, a total of the silicon and the metal element is considered to be 100. When a sufficient amount of the metal element is present in the surface region 3, the silicon in the surface region 3 tends to become amorphous or polycrystalline. As a result, the diffusion of the lithium ions within the silicon particle 1 becomes uniform, and a local volume change in the silicon particle 1 can be suppressed. In addition, when the amount of the metal element in the surface region 3 is set to a predetermined value or less, the charge and discharge capacity of the lithium ion secondary battery is increased. This is because the abundance ratio of the silicon active in the battery reaction in the surface region 3 becomes high.

The thickness of the surface region 3 is, for example, 10 nm or more and 500 nm or less, and preferably 30 nm or more and 300 nm or less. The thickness of the surface region 3 is a thickness in a radial direction of the silicon particle 1. The thickness of the surface region 3 is the average of thicknesses measured at four measurement points in a cross-sectional TEM image of the silicon particle 1 obtained by a transmission electron microscope. The four measurement points are a first measurement point which is arbitrarily selected, a second measurement point which is located at a position rotated 90° from the first measurement point around the geometric center, a third measurement point which is located at a position rotated 180° from the first measurement point around the geometric center, and a fourth measurement point which is located at a position rotated 270° from the first measurement point around the geometric center.

The average particle size of the silicon particles is 1 μm or more and 10 μm or less, preferably 1 μm or more and 8 μm or less, and more preferably 1 μm or more and 7 μm or less. When the average particle size of the silicon particles is within the above-described range, the cycle characteristics are improved. If the silicon particle is too small, a contact area between the silicon particle and an electrolytic solution increases, and thus the risk of a side reaction such as decomposition of the electrolytic solution increases. In addition, if the silicon particle is too large, a risk of a side reaction such as decomposition of the electrolytic solution occurring on a new surface generated by the damage of the silicon particle due to expansion and contraction increases.

In a case in which the silicon particles are available in a particle state, a median size (D50) can be obtained as the average particle size using a particle size distribution measuring device (for example, manufactured by Malvern Panalytical Ltd.). In a case in which the particle size distribution measuring device is used, for example, the average of the particle sizes of 50000 particles is obtained.

In a case in which the silicon particles are present in an electrode and it is difficult to separate the silicon particles from each other, the average particle size can be obtained using at least 100 silicon particles observed in a cross-sectional image. The average particle size measured using the particle size distribution measuring device and the average particle size obtained from the cross-sectional image do not deviate significantly from each other, and they generally match each other.

First, a contrast threshold is set and the silicon particles (the negative electrode material) are extracted from the image. Then, the sizes of at least 100 extracted silicon particles are obtained. The frequencies of the obtained sizes of the silicon particles are plotted graphically, and the most frequent value is taken as the average particle size. In a case in which the shape of the silicon particle is irregular, the size of the major axis is used to calculate the average particle size.

The average circularity of the silicon particles is 0.80 or more and 0.99 or less, preferably 0.910 or more and 0.988 or less, and more preferably 0.920 or more and 0.985 or less.

The average circularity of the silicon particles is obtained using the circularities of at least 100 silicon particles. The circumference length of a circle having the same area as the silicon particle to be measured is divided by the perimeter length of the silicon particle to be measured; and thereby, the circularity is obtained.

In the same manner as for the average particle size, the average circularity can be obtained using the particle size distribution measuring device in a case in which the silicon particles are available in a particle state. In a case in which the particle size distribution measuring device is used, for example, the most frequent value of the circularities of 50000 particles is obtained. In addition, in a case in which it is difficult to separate the silicon particles from each other, it is possible to obtain the average circularity using the cross-sectional image. In a case in which the cross-sectional image is used, for example, the circularity of each of 100 particles is obtained. Specifically, the silicon particles are extracted from the image, and the perimeter length and area of each silicon particle are obtained. In addition, the circumference length of a circle having the same area as the obtained area of each silicon particle is calculated, and the circularity of each silicon particle is calculated. The most frequent value of the circularities of the silicon particles is taken as the average circularity. The average circularity measured using the particle size distribution measuring device and the average circularity obtained from the cross-sectional image do not deviate significantly from each other, and they generally match each other.

The average aspect ratio of the silicon particles is 0.60 or more and 0.99 or less, preferably 0.65 or more and 0.98 or less, and more preferably 0.80 or more and 0.97 or less.

The average aspect ratio of the silicon particles is obtained using the aspect ratios of at least 100 silicon particles. The minor axis length of the silicon particle to be measured is divided by the major axis length of the silicon particle to be measured; and thereby, the aspect ratio is obtained.

In the same manner as for the average particle size, the average aspect ratio can be obtained using the particle size distribution measuring device in a case in which the silicon particles are available in a particle state, or can be obtained using the cross-sectional image in a case in which it is difficult to separate the silicon particles from each other. In a case in which the particle size distribution measuring device is used, for example, the most frequent value of the aspect ratios of 50000 particles is obtained, and in a case in which the cross-sectional image is used, for example, the most frequent value of the aspect ratios of 100 particles is obtained. The average aspect ratio measured using the particle size distribution measuring device and the average aspect ratio obtained from the cross-sectional image do not deviate significantly from each other, and they generally match each other.

The silicon particles present in the electrode after charging and discharging the lithium ion secondary battery do not necessarily have the same average particle size, average aspect ratio, and average circularity as untreated silicon particles available in a particle state. However, if the average particle size, average aspect ratio, and average circularity obtained by any of the methods satisfy the above-described ranges, the cycle characteristics of the lithium ion secondary battery are improved in the subsequent charging and discharging.

The negative electrode material according to the first embodiment can be produced by carrying out a core producing step and a surface region producing step.

In the core producing step, a core of the silicon particle 1 corresponding to the internal region 2 is produced. The core can be produced, for example, by melting silicon and then solidifying it again. Once the silicon is melted, it is possible to make the silicon into a ball shape due to surface tension. For example, an atomization method or a thermal plasma method can be used to melt the silicon. The shape of the core (for example, the average particle size, the average circularity, and the average aspect ratio) varies depending on manufacturing conditions. Since the manufacturing conditions vary to some extent depending on a manufacturing apparatus, it is preferable to determine the actual manufacturing conditions after optimizing the manufacturing conditions in advance.

The producing conditions of the core is as followed, for example. In a case in which the thermal plasma method is used, silicon having an average particle size of 1 μm or more and 8 μm or less is melted as a raw material. The average particle size of the raw material is one of the parameters that affect the particle size of the core. In addition, as the parameters that affect the shape of the core, there are the melting temperature, the melting time, the cooling temperature, the cooling rate, and the like.

The melting temperature of the core is, for example, 1200° C. or higher and 12000° C. or lower. The melting time of the core is, for example, 1 s or more and 300 s or less. The cooling temperature when solidifying the core is, for example, 15° C. or higher and 800° C. or lower. The cooling rate when solidifying the core is, for example, 5° C./s or more and 10000° C./s or less. When the cooling rate is fast, the crystallinity of the particle decreases, and this makes it easier for lithium to diffuse uniformly during charging and discharging; and thereby, the cycle characteristics of the lithium ion secondary battery are improved. The cooling rate is preferably 1000° C./s or more. In addition, the atmosphere in which the silicon is melted and cooled is preferably an inert atmosphere such as Ar or nitrogen.

In a case in which the molten silicon is introduced into a cooling space using a nozzle, the diameter, shape, and length of the nozzle, and the flow rate of the molten silicon to the nozzle are designed. These also affect the shape of the core. The diameter, shape, and length of the nozzle, as well as the flow rate of the molten silicon to the nozzle, are examined in advance to determine the conditions suited to the apparatus.

Next, in the surface region producing step, amorphous silicon or silicon having a crystallite size of 200 nm or less is attached to the surface of the core. In the surface region producing step, a metal element may be attached to the surface of the core. After fine silicon is attached to the surface of the core, a thermal plasma treatment is performed. In the thermal plasma treatment, heat is instantaneously applied; and thereby, the fine silicon is adhered to the surface of the core. The thickness of the surface region 3 can be adjusted by changing the attached amount of the fine silicon. In addition, the crystallite size of the silicon in the surface region 3 can be changed by changing the treatment conditions such as thermal plasma. In addition, the crystallinity of the silicon in the surface region 3 can be changed by attaching the metal element to the surface of the core.

The negative electrode material according to the first embodiment has excellent cycle characteristics for the lithium ion secondary battery. This is because the negative electrode material includes predetermined silicon particles 1. The silicon particle 1 has the fine silicon on the surface. The fine silicon makes the diffusion of the lithium ions in the silicon particle 1 uniform and suppresses a local volume change in the silicon particle 1. In addition, the silicon having a large crystallite size in the internal region 2 of the silicon particle 1 reduces a reaction potential during discharging of the lithium ion secondary battery; and thereby, the discharge capacity of the lithium ion secondary battery is increased.

### “Lithium Ion Secondary Battery”

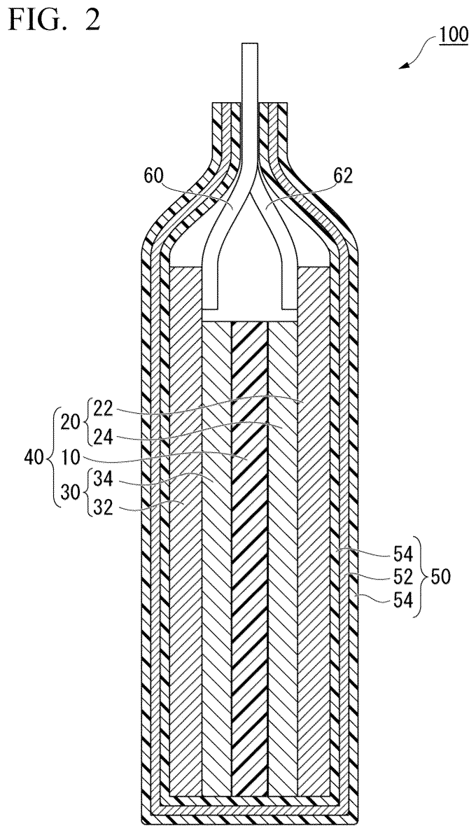

FIG. 2 is a schematic diagram of a lithium ion secondary battery according to the first embodiment. A lithium ion secondary battery 100 shown in FIG. 2 includes a power generating element 40, an exterior body 50, and an electrolyte (for example, a non-aqueous electrolytic solution). The exterior body 50 covers the periphery of the power generating element 40. The power generating element 40 is connected to the outside via a pair of terminals 60 and 62 connected to the power generating element 40. The non-aqueous electrolytic solution is accommodated in the exterior body 50. Although FIG. 2 illustrates an example in which one power generating element 40 is provided inside the exterior body 50, a plurality of power generating elements 40 may be stacked.

### (Power Generating Element)

The power generating element 40 includes a separator 10, a positive electrode 20, and a negative electrode 30. The power generating element 40 may be a laminated body in which these are laminated, or a wound body obtained by winding a structure in which these are laminated.

### <Positive Electrode>

The positive electrode 20 includes, for example, a positive electrode current collector 22 and a positive electrode active material layer 24. The positive electrode active material layer 24 is in contact with at least one surface of the positive electrode current collector 22.

### [Positive Electrode Current Collector]

The positive electrode current collector 22 is, for example, a conductive sheet material. The positive electrode current collector 22 is a thin metal sheet made of, for example, aluminum, copper, nickel, titanium, stainless steel, or the like. Aluminum, which is light in weight, is suitably used for the positive electrode current collector 22. The average thickness of the positive electrode current collector 22 is, for example, 10 μm or more and 30 μm or less.

### [Positive Electrode Active Material Layer]

The positive electrode active material layer 24 includes, for example, a positive electrode active material. The positive electrode active material layer 24 may include a conductive assistant and a binder as necessary.

The positive electrode active material includes an electrode active material capable of reversibly progressing the absorption and release of the lithium ions, the deintercalation and intercalation of the lithium ions, or the doping and dedoping of the lithium ions and counter anions.

The positive electrode active material is, for example, a composite metal oxide. Examples of the composite metal oxide include lithium cobalt oxide (LiCoO₂), lithium nickel oxide (LiNiO₂), lithium manganese oxide (LiMnO₂), spinel lithium manganese oxide (LiMn₂O₄), a compound of a general formula: LiNiₓCo_{y}Mn_{z}MₐO₂ (in the general formula, x+y+z+a=1, 0≤x<1, 0≤y<1, 0≤z<1, 0≤a<1, and M is one or more elements selected from Al, Mg, Nb, Ti, Cu, Zn, and Cr), a lithium vanadium compound (LiV₂O₅), olivine type Li PO₄ (wherein M represents one or more elements selected from Co, Ni, Mn, Fe, Mg, Nb, Ti, Al, and Zr, or VO), lithium titanate (Li₄Ti₅O₁₂), LiNiₓCo_{y}Al_{z}O₂ (0.9<x+y+z<1.1), and the like. The positive electrode active material may be an organic material. For example, the positive electrode active material may be polyacetylene, polyaniline, polypyrrole, polythiophene, or polyacene.

The positive electrode active material may be a lithium-free material. Examples of the lithium-free material include FeF₃, a conjugated polymer including an organic conductive material, a Chevrel phase compound, a transition metal chalcogenide, a vanadium oxide, a niobium oxide, and the like. As the lithium-free material, only one material may be used, or a plurality of materials may be used in combination with each other. In a case in which the positive electrode active material is the lithium-free material, for example, discharging is first performed. Lithium is intercalated into the positive electrode active material by discharging. In addition, lithium may be chemically or electrochemically pre-doped to the positive electrode active material that is the lithium-free material.

The conductive assistant enhances electronic conductivity between the positive electrode active materials. Examples of the conductive assistant include carbon powder, carbon nanotubes, a carbon material, metal fine powder, a mixture of a carbon material and metal fine powder, a conductive oxide, and the like. Examples of the carbon powder include carbon black, acetylene black, ketjen black, and the like. Examples of the fine metal powder include copper powder, nickel powder, stainless steel powder, iron powder, and the like.

The amount of the conductive assistant in the positive electrode active material layer 24 is not particularly limited. For example, the amount of the conductive assistant relative to the total mass of the positive electrode active material, the conductive assistant, and the binder is 0.5 mass % or more and 20 mass % or less, and preferably 1 mass % or more and 5 mass % or less.

The binder in the positive electrode active material layer 24 binds the positive electrode active materials together. As the binder, a known binder can be used. The binder is preferably one that is insoluble in the electrolytic solution, has oxidation resistance, and has adhesive properties. The binder is, for example, a fluororesin. Examples of the binder include polyvinylidene fluoride (PVDF), polyvinyl alcohol (PVA), polytetrafluoroethylene (PTFE), polyamide (PA), polyimide (PI), polyamideimide (PAI), polybenzimidazole (PBI), polyethersulfone (PES), polyacrylic acid and its copolymers, metal ion crosslinked products of polyacrylic acid and its copolymers, maleic anhydride grafted polypropylene (PP) or polyethylene (PE), and mixtures thereof. The binder used in the positive electrode active material layer is particularly preferably PVDF.

The amount of the binder in the positive electrode active material layer 24 is not particularly limited. For example, the amount of the binder relative to the total mass of the positive electrode active material, the conductive assistant, and the binder is 1 mass % or more and 15 mass % or less, and preferably 1.5 mass % or more and 5 mass % or less. If the amount of the binder is low, the adhesive strength of the positive electrode 20 is weakened. If the amount of the binder is high, the binder is electrochemically inactive and does not contribute to the discharge capacity, and thus the energy density of the lithium ion secondary battery 100 becomes low.

### <Negative Electrode>

The negative electrode 30 includes, for example, a negative electrode current collector 32 and a negative electrode active material layer 34. The negative electrode active material layer 34 is formed on at least one surface of the negative electrode current collector 32.

### [Negative Electrode Current Collector]

The negative electrode current collector 32 is, for example, a conductive sheet material. As the negative electrode current collector 32, a material that is the same as the positive electrode current collector 22 can be used.

### [Negative Electrode Active Material Layer]

The negative electrode active material layer 34 includes a negative electrode active material and a binder. The negative electrode active material layer may include a conductive assistant, a dispersion stabilizer, and the like, as necessary. As the negative electrode active material, the above-mentioned negative electrode material is used. By using the above-mentioned negative electrode material as the negative electrode active material, the cycle characteristics of the lithium ion secondary battery 100 are improved.

As the conductive assistant and the binder, materials that are the same as those of the positive electrode 20 can be used. Examples of the binder in the negative electrode 30 may include cellulose, styrene-butadiene rubber, ethylene-propylene rubber, polyimide resin, polyamide-imide resin, acrylic resin, or the like, in addition to those exemplified for the positive electrode 20. The cellulose may be, for example, carboxymethyl cellulose (CMC).

### <Separator>

The separator 10 is sandwiched between the positive electrode 20 and the negative electrode 30. The separator 10 separates the positive electrode 20 and the negative electrode 30 from each other and prevents a short circuit between the positive electrode 20 and the negative electrode 30. The separator 10 extends in-plane along the positive electrode 20 and the negative electrode 30. The lithium ions can pass through the separator 10.

The separator 10 has, for example, an electrically insulating porous structure. The separator 10 is, for example, a monolayer or laminated body of a polyolefin film. The separator 10 may be a stretched film of a mixture of polyethylene, polypropylene, and the like. The separator 10 may be a nonwoven fabric of a fiber made of at least one constituent material selected from the group consisting of cellulose, polyester, polyacrylonitrile, polyamide, polyethylene, and polypropylene. The separator 10 may be, for example, a solid electrolyte. The solid electrolyte is, for example, a polymer solid electrolyte, an oxide-based solid electrolyte, or a sulfide-based solid electrolyte. The separator 10 may be an inorganic coated separator. The inorganic coated separator is formed by applying a mixture of a resin such as PVDF or CMC and an inorganic substance such as alumina or silica on the surface of the above-mentioned film. The inorganic coated separator has excellent heat resistance and suppresses the deposition (precipitation) of a transition metal eluted from the positive electrode onto the surface of the negative electrode.

### <Electrolytic Solution>

The electrolytic solution is enclosed in the exterior body 50 and is impregnated in the power generating element 40. The electrolytic solution is not limited to a liquid electrolyte, but may be a solid electrolyte. The non-aqueous electrolytic solution includes, for example, a non-aqueous solvent and an electrolytic salt. The electrolytic salt is dissolved in the non-aqueous solvent.

The solvent is not particularly limited as long as it is a solvent generally used in the lithium ion secondary battery. The solvent includes, for example, any one of a cyclic carbonate compound, a chain carbonate compound, a cyclic ester compound, and a chain ester compound. The solvent may include these compounds in any mixture ratio. Examples of the cyclic carbonate compound include ethylene carbonate (EC), propylene carbonate (PC), fluoroethylene carbonate, vinylene carbonate, and the like. Examples of the chain carbonate compound include diethyl carbonate (DEC), ethyl methyl carbonate (EMC), and the like. Examples of the cyclic ester compound include γ-butyrolactone, and the like. Examples of the chain ester compound include propyl propionate, ethyl propionate, ethyl acetate, and the like.

The electrolytic salt is, for example, a lithium salt. Examples of the electrolyte include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, LiN(FSO₂)₂, and the like. As the lithium salt, one of these compounds or a mixture of two or more thereof may be used. From the viewpoint of the degree of electrolytic dissociation, the electrolyte preferably includes LiPF₆. The dissociation rate of the electrolytic salt in the carbonate solvent at room temperature is preferably 10% or more.

The electrolytic solution is preferably one in which LiPF₆ is dissolved in the carbonate solvent, for example. The concentration of LiPF₆ is, for example, 1 mol/L. In a case in which the polyimide resin includes a large amount of aromatic, the polyimide resin may exhibit charging behavior similar to that of soft carbon. In a case in which the electrolytic solution is a carbonate electrolytic solution solvent including a cyclic carbonate, lithium can be reacted uniformly with the polyimide. In this case, the cyclic carbonate is preferably ethylene carbonate, fluoroethylene carbonate, or vinylene carbonate.

### <Exterior Body>

The exterior body 50 seals the power generating element 40 and the non-aqueous electrolytic solution therein. The exterior body 50 prevents leakage of the non-aqueous electrolytic solution to the outside and prevents moisture and the like from entering the inside of the lithium ion secondary battery 100 from the outside.

As shown in FIG. 1, the exterior body 50 has a metal foil 52 and a resin layer 54 laminated on each side of the metal foil 52. The exterior body 50 is a metal laminate film in which both sides of the metal foil 52 are coated with a polymer film (the resin layer 54).

The metal foil 52 may be, for example, an aluminum foil. As the resin layer 54, a polymer film such as polypropylene can be used. The material constituting the resin layer 54 may be different between the inner side and the outer side. For example, as the material on the outer side, a polymer with a high melting point, for example, polyethylene terephthalate (PET), polyamide (PA), or the like can be used, and as the material of the polymer film on the inner side, polyethylene (PE), polypropylene (PP), or the like can be used.

### <Terminal>

The terminals 62 and 60 are connected to the positive electrode 20 and the negative electrode 30, respectively. The terminal 62 connected to the positive electrode 20 is a positive terminal, and the terminal 60 connected to the negative electrode 30 is a negative terminal. The terminals 60 and 62 serve to electrically connect the power generating element to the outside. The terminals 60 and 62 are formed from a conductive material such as aluminum, nickel, or copper. A connection method may be welding or screwing. The terminals 60 and 62 are preferably protected with insulating tape to prevent a short circuit.

### “Method of Manufacturing Lithium Ion Secondary Battery”

The lithium ion secondary battery 100 is produced by preparing the negative electrode 30, the positive electrode 20, the separator 10, the electrolytic solution, and the exterior body 50, and assembling them. An example of a method of manufacturing the lithium ion secondary battery 100 will be described below.

The negative electrode 30 is produced, for example, by sequentially carrying out a slurry producing step, an electrode application step, a drying step, and a rolling step.

The slurry producing step is a step of mixing a negative electrode active material, a binder, a conductive assistant, and a solvent to make a slurry. As the negative electrode active material, the above-mentioned negative electrode material is used. When a dispersion stabilizer is added to the slurry, it is possible to suppress aggregation of the negative electrode active material.

The slurry producing step is a step of mixing a negative electrode active material, a binder, a conductive assistant, and a solvent to make a slurry. The solvent is, for example, water, N-methyl-2-pyrrolidone, or the like. The composition ratio, by mass, of the negative electrode active material, the conductive material, and the binder is preferably 70 wt % to 100 wt %: 0 wt % to 10 wt %: 0 wt % to 20 wt %. The mass ratio of these is adjusted such that the total is 100 wt %. A container used for producing the slurry is preferably made of a metal such as SUS. In a case in which a polar solvent such as N-methyl-2-pyrrolidone is used as the solvent, the capacitance of an oxide film on each of the surfaces of the silicon particles increases. The polar solvent prevents repulsion between the conductive assistant and the silicon particles. By suppressing the repulsion, it is possible to prevent the capacity of the lithium ion secondary battery from decreasing.

The negative electrode active material may be a material composited by mixing active material particles and a conductive material while a shearing force is applied thereto. When the active material particles are mixed while the shear force is applied thereto to the extent that the active material particles are not altered, the surfaces of the active material particles are coated with the conductive material. In addition, the particle size of the negative electrode active material can be adjusted by the degree of mixing. In addition, the produced negative electrode active material may be sieved to make the particle size uniform.

The electrode application step is a step of applying the slurry to the surface of the negative electrode current collector 32. A method of applying a slurry is not particularly limited. For example, a slit die coating method or a doctor blade method can be used as the method of applying a slurry. The slurry is applied, for example, at room temperature.

The drying step is a step of removing the solvent from the slurry. For example, the negative electrode current collector 32 on which the slurry is applied is dried in an atmosphere of 80° C. or higher and 350° C. or lower.

The rolling step is carried out as necessary. The rolling step is a step of applying a pressure to the negative electrode active material layer 34 to adjust the density of the negative electrode active material layer 34. The rolling step is carried out, for example, using a roll press apparatus.

The positive electrode 20 can be produced in the same procedure as that for the negative electrode 30. As the separator 10 and the exterior body 50, commercially available products can be used.

Next, the produced positive electrode 20 and negative electrode 30 are laminated such that the separator 10 is located between them; and thereby, the power generating element 40 is produced. In a case in which the power generating element 40 is a wound body, the positive electrode 20, the negative electrode 30, and the separator 10 are wound with one end side thereof as an axis.

Finally, the power generating element 40 is enclosed in the exterior body 50. The non-aqueous electrolytic solution is injected into the exterior body 50. After the non-aqueous electrolytic solution is injected, the pressure is reduced, heating is performed, and the like, and thus the non-aqueous electrolytic solution is impregnated into the power generating element 40. The exterior body 50 is sealed by applying heat or the like; and thereby, the lithium ion secondary battery 100 is obtained. Instead of injecting the electrolytic solution into the exterior body 50, the power generating element 40 may be immersed in the electrolytic solution. After the liquid is injected into the power generating element, the power generating element is preferably left to stand for 24 hours.

The lithium ion secondary battery 100 according to the first embodiment has excellent cycle characteristics because the negative electrode active material includes a negative electrode material having a predetermined shape.

The embodiments of the present disclosure have been described in detail with reference to the drawings, but configuration, combinations thereof, and the like in the embodiments are merely examples, and additions, omissions, substitutions, and other modifications in the configurations are possible without departing from the features of the present disclosure.

### EXAMPLES

### Example 1

A positive electrode slurry was applied to one surface of an aluminum foil having a thickness of 15 μm. The positive electrode slurry was produced by mixing a positive electrode active material, a conductive assistant, a binder, and a solvent.

As the positive electrode active material, LiₓCoO₂ was used. As the conductive assistant, acetylene black was used. As the binder, polyvinylidene fluoride (PVDF) was used. As the solvent, N-methyl-2-pyrrolidone was used. The positive electrode slurry was produced by mixing 97 parts by mass of the positive electrode active material, 1 part by mass of the conductive assistant, 2 parts by mass of the binder, and 70 parts by mass of the solvent. The amount of the positive electrode active material carried in a positive electrode active material layer after drying was 25 mg/cm². The solvent was removed from the positive electrode slurry in a drying furnace to make the positive electrode active material layer. The positive electrode active material layer was pressed using a roll press to produce a positive electrode.

Next, a negative electrode active material to be added to a negative electrode slurry was prepared. First, as a core, silicon particles having an average particle size of 5.1 μm, an average circularity of 0.949, and an average aspect ratio of 0.90 were used. The average particle size, the average circularity, and the average aspect ratio were obtained by measuring 50000 particles using a particle size analyzer manufactured by Malvern Panalytical Ltd. Next, silicon having a crystallite size of 21 nm was attached to the surface of the core. The attachment of the silicon having a small crystallite size to the core surface was carried out using a thermal plasma method.

A cross section of the produced negative electrode active material was observed using TEM. The negative electrode active material had an internal region and a surface region. The average particle size, the average circularity, and the average aspect ratio of the negative electrode active material were almost the same as those of the core. The thickness of the surface region was 459 nm.

Next, the negative electrode slurry was produced using this negative electrode active material. As the conductive assistant, carbon black was used. As the binder, a polyimide resin was used. As the solvent, N-methyl-2-pyrrolidone was used. The negative electrode slurry was produced by mixing 90 parts by mass of the negative electrode active material, 5 parts by mass of the conductive assistant, and 5 parts by mass of the binder in the N-methyl-2-pyrrolidone.

Then, the negative electrode slurry was applied onto one surface of a copper foil having a thickness of 10 μm and dried. The amount of the negative electrode active material carried in a negative electrode active material layer after drying was 2.5 mg/cm². The negative electrode active material layer was pressed using a roll press and then sintered in a nitrogen atmosphere at 300° C. or higher for 5 hours.

Next, an electrolytic solution was produced. In a solvent of the electrolytic solution, fluoroethylene carbonate (FEC):ethylene carbonate (EC):diethyl carbonate (DEC)=10% by volume: 20% by volume: 70% by volume. In addition, an additive for improving output, an additive for suppressing gas, an additive for improving cycle characteristics, and an additive for improving safety performance were added to the electrolytic solution. As an electrolytic salt, LiPF₆ was used. The concentration of LiPF₆ was 1 mol/L.

### (Production of Lithium Ion Secondary Battery for Evaluation)

The produced negative electrode and positive electrode were laminated with a separator (porous polyethylene sheet) interposed between them such that the positive electrode active material layer and the negative electrode active material layer faced each other, to obtain a laminated body. This laminated body was inserted into an exterior body made of an aluminum laminate film and heat-sealed except for one portion on the periphery thereof to form a closed portion. Finally, after the electrolytic solution was injected into the exterior body, a remaining portion was heat-sealed while reducing the pressure using a vacuum sealer, to produce a lithium ion secondary battery. The produced lithium ion secondary battery was left to stand for 24 hours.

(Measurement of Capacity Retention Rate after 300 Cycles)

The cycle characteristics of the lithium ion secondary battery were measured. The cycle characteristics were measured using a secondary battery charging and discharging test device (manufactured by Hokuto Denko Corporation).

The battery was charged at a constant current charge rate of 1 C (a current value at which charging was completed in 1 hour when constant current charging was performed at 25° C.) until a battery voltage reached 4.2 V, and then discharged at a constant current discharge rate of 1.0 C until the battery voltage reached 2.5 V. The discharge capacity after the completion of charging and discharging was detected to obtain a battery capacity Q₁ before the cycle test. The battery capacity Q₁ was 3684 mAh/g.

The battery whose battery capacity Q₁ was obtained above was again charged using the secondary battery charging and discharging test device at a constant current charge rate of 1 C until a battery voltage reached 4.2 V, and then discharged at a constant current discharge rate of 1 C until the battery voltage reached 2.5 V. The above-described charging and discharging was counted as one cycle, and 300 cycles of charging and discharging were performed. Thereafter, the discharge capacity after 300 cycles of charging and discharging was detected to obtain a battery capacity Q₂ after 300 cycles. From the battery capacities Q₁ and Q₂ obtained above, a capacity retention rate E after 300 cycles was obtained. The capacity retention rate E was obtained by E=Q₂/Q₁×100. The capacity retention rate of Example 1 was 82%.

### Examples 2 to 4

Examples 2 to 4 differ from Example 1 in that the average particle size of the negative electrode active material was changed. The average particle size of the negative electrode active material was adjusted by changing the size of the core when the negative electrode active material was produced. Other conditions were the same as in Example 1, and the capacity retention rate after 300 cycles was obtained.

### Examples 5 and 6

Examples 5 and 6 differ from Example 1 in that the crystallite size of the internal region of the negative electrode active material was changed. The crystallite size of the internal region of the negative electrode active material was changed by changing the heat treatment conditions when the core was produced. Other conditions were the same as in Example 1, and the capacity retention rate after 300 cycles was obtained.

### Examples 7 to 9

Examples 7 to 9 differ from Example 1 in that the crystal state of the surface region of the negative electrode active material was changed. The crystallite size of the surface region of the negative electrode active material was changed by changing the conditions of the thermal plasma treatment after the fine silicon was attached to the core. In Example 9, the silicon was amorphous silicon. Other conditions were the same as in Example 1, and the capacity retention rate after 300 cycles was obtained.

### Examples 10 to 22

Examples 10 to 22 differ from Example 1 in that a metal element was added to the surface region of the negative electrode active material. The metal element was attached together with the silicon having a small crystallite size when the silicon was attached to the surface of the core. Other conditions were the same as in Example 1, and the capacity retention rate after 300 cycles was obtained.

### Examples 23 to 26

Examples 23 to 26 differ from Example 11 in that the molar ratio of the metal element in the surface region of the negative electrode active material was changed. Other conditions were the same as in Example 11, and the capacity retention rate after 300 cycles was obtained.

### Examples 27 to 30

Examples 27 to 30 differ from Example 1 in that the thickness of the layer including the silicon having a small crystallite size and formed on the surface of the negative electrode active material was changed. The thickness of this layer was changed by changing the attached amount of the silicon having a small crystallite size to the core when the negative electrode active material was produced. Other conditions were the same as in Example 1, and the capacity retention rate after 300 cycles was obtained.

### Examples 31 to 34

Examples 31 to 34 differ from Example 1 in that the average circularity and the average aspect ratio of the negative electrode active material were changed. This ratio could be adjusted by changing the heat treatment conditions when the core was produced. Other conditions were the same as in Example 1, and the capacity retention rate after 300 cycles was obtained.

### Comparative Example 1

Comparative Example 1 differs from Example 1 in that the silicon having a small crystallite size was not attached to the surface after the core was produced. That is, the negative electrode active material of Comparative Example 1 consisted of only the core. Other conditions were the same as in Example 1, and the capacity retention rate after 300 cycles was obtained.

### Comparative Example 2

Comparative Example 2 differs from Example 1 in that the crystallite size of the surface region of the negative electrode active material was changed. Other conditions were the same as in Example 1, and the capacity retention rate after 300 cycles was obtained.

### Comparative Example 3

Comparative Example 3 differs from Example 1 in that the crystallite size of the internal region of the negative electrode active material was changed. Other conditions were the same as in Example 1, and the capacity retention rate after 300 cycles was obtained.

The results of Examples 1 to 34 and Comparative Examples 1 to 3 were summarized in the following table. The negative electrode active materials of Examples 2 to 34 and Comparative Examples 1 to 3 were also affected by variations in manufacturing conditions in addition to the intentionally changed parameters, and some of them were deviated from the various parameters of the negative electrode active material of Example 1.

TABLE 1

| | | | | Internal | Surface | | Metal | Fine | | |
|---|---|---|---|---|---|---|---|---|---|---|
| | Average | | | region | region | | element | silicon | | Capacity |
| | particle | | Average | crystallite | crystallite | | molar | layer | Discharge | retention |
| | size | Average | aspect | size | size | Metal | ratio | thickness | capacity | rate |
| | (μm) | circularity | ratio | (nm) | (nm) | element | (mol %) | (nm) | (mAh/g) | (%) |
| Example 1 | 5.1 | 0.949 | 0.90 | 2858 | 21 | — | — | 459 | 3684 | 82 |
| Example 2 | 1 | 0.935 | 0.87 | 212 | 21 | — | — | 90 | 3718 | 82 |
| Example 3 | 7 | 0.937 | 0.88 | 3591 | 22 | — | — | 630 | 3715 | 83 |
| Example 4 | 10 | 0.946 | 0.84 | 4521 | 24 | — | — | 900 | 3675 | 78 |
| Example 5 | 5.3 | 0.950 | 0.90 | 300 | 20 | — | — | 477 | 3645 | 81 |
| Example 6 | 5.6 | 0.950 | 0.90 | 5000 | 23 | — | — | 504 | 3651 | 80 |
| Example 7 | 5.6 | 0.950 | 0.90 | 1582 | 10 | — | — | 504 | 3648 | 86 |
| Example 8 | 5.7 | 0.950 | 0.90 | 2149 | 200 | — | — | 513 | 3645 | 81 |
| Example 9 | 6.5 | 0.950 | 0.90 | 1249 | Amorphous | — | — | 585 | 3678 | 85 |
| Example 10 | 7.3 | 0.954 | 0.93 | 286 | 24 | Mg | 10 | 657 | 3215 | 94 |
| Example 11 | 6.5 | 0.962 | 0.95 | 310 | 8 | Al | 10 | 585 | 3195 | 91 |
| Example 12 | 4.6 | 0.946 | 0.84 | 305 | 121 | Ca | 10 | 414 | 3158 | 91 |
| Example 13 | 3.6 | 0.937 | 0.88 | 1825 | 12 | Ti | 10 | 324 | 3162 | 90 |
| Example 14 | 4.6 | 0.964 | 0.92 | 315 | 9 | V | 10 | 414 | 3149 | 94 |
| Example 15 | 5.6 | 0.967 | 0.95 | 322 | 5 | Cr | 10 | 504 | 3162 | 95 |
| Example 16 | 8.4 | 0.940 | 0.85 | 3841 | 8 | Mo | 10 | 756 | 3015 | 94 |
| Example 17 | 3.6 | 0.925 | 0.81 | 300 | 118 | Mn | 10 | 324 | 3056 | 91 |
| Example 18 | 4.7 | 0.936 | 0.89 | 312 | 21 | Fe | 10 | 423 | 3154 | 90 |
| Example 19 | 6.4 | 0.965 | 0.96 | 1284 | 25 | Co | 10 | 576 | 3075 | 92 |
| Example 20 | 8.4 | 0.935 | 0.87 | 3125 | 182 | Ni | 10 | 756 | 3061 | 91 |
| Example 21 | 4.7 | 0.983 | 0.97 | 360 | 151 | Cu | 10 | 423 | 3070 | 91 |
| Example 22 | 5.7 | 0.952 | 0.95 | 350 | 120 | Zn | 10 | 513 | 3058 | 91 |

TABLE 2

| | | | | Internal | Surface | | Metal | Fine | | |
|---|---|---|---|---|---|---|---|---|---|---|
| | Average | | | region | region | | element | silicon | | Capacity |
| | particle | | Average | crystallite | crystallite | | molar | layer | Discharge | retention |
| | size | Average | aspect | size | size | Metal | ratio | thickness | capacity | rate |
| | (μm) | circularity | ratio | (nm) | (nm) | element | (mol %) | (nm) | (mAh/g) | (%) |
| Example 23 | 5.7 | 0.967 | 0.95 | 1299 | 45 | Fe | 0.5 | 570 | 3142 | 84 |
| Example 24 | 7.4 | 0.940 | 0.85 | 3419 | 41 | Fe | 1 | 740 | 2751 | 90 |
| Example 25 | 6.7 | 0.931 | 0.84 | 4712 | 37 | Fe | 40 | 670 | 2257 | 88 |
| Example 26 | 5.7 | 0.924 | 0.85 | 2491 | 48 | Fe | 45 | 570 | 2201 | 85 |
| Example 27 | 5.7 | 0.972 | 0.97 | 3481 | 61 | — | — | 12 | 3684 | 80 |
| Example 28 | 5.4 | 0.935 | 0.87 | 2129 | 47 | — | — | 54 | 3712 | 86 |
| Example 29 | 5.6 | 0.948 | 0.95 | 1249 | 31 | — | — | 847 | 3648 | 85 |
| Example 30 | 5.7 | 0.947 | 0.92 | 3139 | 50 | — | — | 1409 | 3684 | 82 |
| Example 31 | 8.5 | 0.910 | 0.79 | 4818 | 158 | — | — | 1275 | 3675 | 79 |
| Example 32 | 5.7 | 0.920 | 0.80 | 3848 | 19 | — | — | 855 | 3719 | 84 |
| Example 33 | 5.3 | 0.985 | 0.97 | 48 | 79 | — | — | 795 | 3618 | 85 |
| Example 34 | 6.4 | 0.990 | 0.98 | 558 | 145 | — | — | 960 | 3657 | 80 |
| Comparative | 5.4 | 0.964 | 0.92 | 2484 | — | — | — | — | 3731 | 48 |
| Example 1 | | | | | | | | | | |
| Comparative | 6.7 | 0.967 | 0.95 | 3485 | 300 | — | — | 1005 | 3689 | 43 |
| Example 2 | | | | | | | | | | |
| Comparative | 5.4 | 0.940 | 0.85 | 100 | 23 | — | — | 810 | 3712 | 46 |
| Example 3 | | | | | | | | | | |

Examples 1 to 34 had higher capacity retention rates and better cycle characteristics than Comparative Examples 1 to 3.

### REFERENCE SIGNS LIST

1 Silicon particle
2 Internal region
3 Surface region
10 Separator
20 Positive electrode
22 Positive electrode current collector
24 Positive electrode active material layer
30 Negative electrode
32 Negative electrode current collector
34 Negative electrode active material layer
40 Power generating element
50 Exterior body
52 Metal foil
54 Resin layer
60, 62 Terminal
100 Lithium ion secondary battery

1. A negative electrode material for a lithium ion secondary battery, comprising silicon particles,
wherein the silicon particles have an average particle size of 1 μm or more and 10 μm or less,
wherein each of the silicon particles has an internal region and a surface region,
wherein the surface region includes amorphous silicon or silicon having a crystallite size of 200 nm or less, and
wherein the internal region includes silicon having a crystallite size of more than 200 nm.

2. The negative electrode material for a lithium ion secondary battery according to claim 1, wherein the surface region includes at least one metal element selected from the group consisting of Mg, Al, Ca, Ti, V, Cr, Mo, Mn, Fe, Co, Ni, Cu, and Zn.

3. The negative electrode material for a lithium ion secondary battery according to claim 2, wherein a molar ratio of the metal element in the surface region is 1 mol % or more and 40 mol % or less.

4. The negative electrode material for a lithium ion secondary battery according to claim 1,
wherein an average circularity of the silicon particles is 0.920 or more and 0.985 or less, and
wherein an average aspect ratio of the silicon particles is 0.80 or more and 0.97 or less.

5. The negative electrode material for a lithium ion secondary battery according to claim 1, wherein the average particle size of the silicon particles is 1 μm or more and 7 μm or less.

6. The negative electrode material for a lithium ion secondary battery according to claim 1, wherein the internal region includes the silicon having the crystallite size of 200 nm or more and 2000 nm or less.

7. The negative electrode material for a lithium ion secondary battery according to claim 6, wherein the internal region includes the silicon having the crystallite size of 200 nm or more and 1500 nm or less.

8. The negative electrode material for a lithium ion secondary battery according to claim 7, wherein the internal region includes the silicon having the crystallite size of 300 nm or more and 1000 nm or less.

9. The negative electrode material for a lithium ion secondary battery according to claim 1, wherein the internal region includes a silicon oxide or a silicon carbon composite material.

10. The negative electrode material for a lithium ion secondary battery according to claim 1, wherein the surface region includes the silicon having the crystallite size of 5 nm or more and 200 nm or less.

11. The negative electrode material for a lithium ion secondary battery according to claim 1, wherein a thickness of the surface region is 10 nm or more and 500 nm or less.

12. The negative electrode material for a lithium ion secondary battery according to claim 11, wherein the thickness of the surface region is 30 nm or more and 300 nm or less.

13. The negative electrode material for a lithium ion secondary battery according to claim 2, wherein the metal element is present as a simple substance or a silicide.

14. The negative electrode material for a lithium ion secondary battery according to claim 13, wherein the silicide comprises at least one selected from the group consisting of FeSi₂, FeSi, Fe₃Si, CrSi₂, NiSi₂, MoSi₂, VS₂, Mg₂Si, and TiSi₂.

15. The negative electrode material for a lithium ion secondary battery according to claim 3, wherein the molar ratio of the metal element in the surface region is 3 mol % or more and 30 mol % or less.

16. The negative electrode material for a lithium ion secondary battery according to claim 1,
wherein an average circularity of the silicon particles is 0.80 or more and 0.99 or less, and
wherein an average aspect ratio of the silicon particles is 0.60 or more and 0.99 or less.

17. The negative electrode material for a lithium ion secondary battery according to claim 1, wherein the internal region is a polycrystalline body formed by aggregation of single crystals.

18. The negative electrode material for a lithium ion secondary battery according to claim 1, wherein the internal region further comprises a grain boundary.

19. A negative electrode for a lithium ion secondary battery, comprising the negative electrode material for a lithium ion secondary battery according to claim 1.

20. A lithium ion secondary battery comprising the negative electrode for a lithium ion secondary battery according to claim 19, a positive electrode, and an electrolyte.
